(19) United States
(12) Patent Application Publication
(10) Pub. No.: US 2007/0284415 A1
(43) Pub. Date: Dec. 13, 2007

(54) SEMICONDUCTOR HAVING A BONDING WIRE AND PROCESS

(75) Inventor: Khalil Hosseini, Weihmichl (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Muenchen (DE)

(21) Appl. No.: 11/750,051

(22) Filed: May 21, 2007

(30) Foreign Application Priority Data
May 17, 2006 (DE) 10 2006 023 167.8

(51) Int. Cl. A47J 36/02

(52) U.S. Cl. 228/101

(57) ABSTRACT

A semiconductor device having a bonding wire is disclosed. In one embodiment, it is a bonding wire for use in a wedge-wedge bonding process for bonding a semiconductor element. One embodiment includes a metallic wire core of greater hardness and a high electric and thermal conductivity and a metallic coating of lower hardness enveloping the wire core.

### CROSS-REFERENCE TO RELATED APPLICATIONS

This Utility Patent Application claims priority to German Patent Application No. DE 10 2006 023 167.8 filed on May 17, 2006, which is incorporated herein by reference.

### BACKGROUND

The invention relates to a semiconductor device, a bonding wire, a manufacturing process for a semiconductor device having a bonding wire, and a wedge-wedge wire bonding process.

When an electronic semiconductor element, for example a semiconductor chip, a transistor or a diode, is bonded, the contacts existing in the semiconductor element, referred to as pads, are connected to external contacts, the pins, by using a bonding wire. In the area of power electronics, in particular in the case of MOSFET transistors or power diodes, according to the state of the art highly pure aluminum bonding wires with a diameter, dependent on the current load, of 25 to 50 μm or 125 to 500 μm are used.

Among other things, a wedge-wedge method is used to bond the bonding wire onto the pads and pins. The end of the bonding wire is pressed by using a wedge or needle-shaped bonding tool, the wedge, onto the area to be bonded, the bond pad. By using a short ultrasound impulse, the bonding wire is then melted on and fused to the bond pad's surface. The electrical bond between the bonding wire and the bond pad is formed. With the bonding wire moved along with it, the wedge then moves from the first bonding point, e.g., located on the semiconductor element, to the second bonding point on the pins. The bonding process is repeated here, whereby the bonding wire is additionally cut off. As a result, a wire jumper is produced between the pad and the pin. The wedge is then removed from the area of the pad and pin, taking the cut-off part of the bonding wire with it. The binding head with the wedge is then moved to the next bonding point, and the bonding process described is repeated.

Increasing demands on the performance of electrical and thermal bonding of the semiconductor element with the surrounding housing, the package, call for the use of other materials for the bonding wire. Thus, it is particularly advantageous to use bonding wires made of copper, copper alloys or comparable metals with better electrical and thermal conductivity values to boost the current carrying capacity of the housing and the efficiency of heat transport out of the semiconductor element.

However, previously unsolved problems have arisen in the wedge-wedge bonding process when using bonding wire made of copper. The greater hardness of the copper calls for a greater intensity of the ultrasound in combination with an increased pressing forces of the wedge on the bonding point. It has been found that this may lead to damaging or even destruction of the pads on the semiconductor element. These higher bonding parameters lead to a situation in which the plating of the pad can be pierced or, moreover, the doped structure of the semiconductor element may be destroyed. As a result, for example in the case of the semiconductor elements of MOS-FET transistors, short-circuits generally occur between the gate and source bonds after wedge-wedge bonding.

Destruction of the pad plating and the doped semiconductor structure due to the increased bonding parameters is referred to as crater formation or cratering and makes it impossible to use the wedge-wedge bonding process for bonding wires with a material other than aluminum, which is highly advantageous for high quantities and production speeds. This is why it is either necessary to do away with the use of copper for binding or it is necessary to fall back on costly additional or palliative developments such as more expensive bond pad platings.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates an exemplary cross-section of a coated bonding wire.

FIG. 2 illustrates a coated bonding wire with an additional adhesion promotion layer.

FIG. 3 illustrates an exemplary sputter coating system for continuous wire coating.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One or more embodiments provide a semiconductor device, including an improved bonding wire that is to be used in a wedge-wedge bonding process with the usual bonding parameters, which rule out cratering. The task of specifying a simple and cost-effective manufacturing process for such a bonding wire also presents itself. Finally, in connection with this, the embodiment is also to specify a wedge-wedge ultrasound wire bonding process with the improved bonding wire.

In one embodiment, the bonding wire is for use in a wedge-wedge ultrasound wire bonding process for bonding a semiconductor element, and includes a metallic wire core of higher hardness and higher electrical and thermal conductivity and a metallic coating of lower hardness that envelops the wire core. In one embodiment, a semiconductor device is disclosed, including a semiconductor coupled to an external pad via at least one bonding wire.

Practical experience has shown that a higher electrical and thermal conductivity goes hand in hand with increased hardness of the materials used for bonding. The hardness of the material is crucially important in the wedge-wedge wire bonding process and must be taken into consideration when setting the bonding parameters.

One or more embodiments provide for enveloping a wire core of higher hardness and higher electrical and thermal conductivity with a metallic material of lower hardness. This envelopment entails more favourable bonding parameters for realization of the wedge-wedge bonding process. It thus warrants non-destructive bonding, while the wire core produces improved electrical and thermal conductivity in comparison with usual Al bonding wires.

In one embodiment, the wire core consists of copper or a copper alloy. The coating consists of a light metal, in particular aluminum or an aluminum alloy. In this embodiment, wedge-wedge bonding is possible with similar bonding parameters to the ones used for aluminum, while the bonding wire has a thermal and electrical conductivity that is essentially equivalent to that of a bonding wire made of the corresponding metal, for example copper.

In one embodiment, the wire core has a diameter in the range of up to 1 mm, up to 500 μm. The thickness of the coating lies in an expedient range of up to 3 μm, up to 600 nm. Such a bonding wire has the usual dimensions of an aluminum bonding wire, but the aluminum coating warrants non-destructive bonding.

In one embodiment, the coating also exhibits a surface oxide coating with a layer thickness of up to 20 nm. The oxide layer protects the material underneath it against progressive corrosion and has a passivating effect.

The manufacturing process for a bonding wire according to the invention includes coating of a metallic wire bonding blank in a gas phase deposition process with a highly pure metallic coating of lower hardness for creation of a coated bonding wire.

A wire bonding blank whose diameter and cross-section exhibits the electrical or thermal function parameters later required is thus provided with a coating that warrants non-destructive wedge-wedge wire bonding. The gas deposition process warrants a highly pure and homogeneous coating on the one hand and precise adjustment of the layer thickness of the metallic coating on the other hand.

A series of diverse processes can be applied as the gas deposition process. A sputtering process is used in a first embodiment of the manufacturing process. The gas phase of the coating material is generated by particles ejected into a vacuum out of a target by using a zone current. These deposit in a precisely controllable layer thickness on the wire bonding blank located in the proximity.

A vacuum vapour deposition process is applied in a second embodiment. The gas phase of the coating is produced by heating up a sample of the coating material with resulting vaporisation and subsequent deposition of the sample's vapour on the wire bonding blank in a controllable layer thickness.

As already mentioned, the wire bonding blank consists of copper or a copper alloy, and the coating target consists in particular of aluminum or an aluminum alloy.

In one embodiment, before the gas deposition phase begins, a reduction process is expediently realized on an oxide layer located on the wire bonding blank. This process serves to improve adhesion of the coating on the wire bonding blank blank and to minimise the thermal and electrical contact resistance between the coating and the wire bonding blank.

The wedge-wedge ultrasound wire bonding process according to the invention is distinguished by use of a bonding wire with a metallic wire core of greater hardness and a metallic coating enveloping the wire core of lower hardness. At least one bonding parameter, in one embodiment a pressing forces of a wedge onto a bonding point and/or an ultrasound intensity applied to the wedge, is in particular set to a usual, in one embodiment a lower value for bonding a bonding wire consisting completely of the material of the metallic coating.

Therefore, in other words, the bonding wire consisting of the metallic wire core is bonded with such bonding parameters onto the corresponding bonding points, the pads and pins, which is determined exclusively by the material of the coating. Accordingly, bonding wires consisting of a wire core with a first, harder material are bonded under generally far more favourable conditions, while the bonding wire essentially exhibits all electrical and thermal characteristics of the wire core material.

What is particularly expedient is that at least one of the actual bonding parameters is set to a lower value than a value of the bonding parameter required for the metallic wire core. Therefore, for example, bonding can actually take place at a lower pressing force and/or with a lower ultrasound intensity than would be necessary for a wire consisting entirely of the core material. Thus, damage to the bonding point due to excessive bonding parameters are very effectively avoided.

In one embodiment, in the case of a metallic coating consisting of aluminum or an aluminum coating enveloping a metallic wire core made of copper or a copper alloy, the pressing force of the wedge corresponds to the usual pressing force for a bonding wire made of aluminum or the aluminum alloy. As a result, in relation to their function, bonding wires made of copper can be bonded with a lower pressing force, and thus non-destructively, than conventional aluminum wires.

Equally, in the case of a further embodiment, the ultrasound intensity at the tip of the wedge can correspond to the usual ultrasound intensity for a bonding wire made of aluminum or the aluminum alloy. In this case, the ultrasound intensity is set to the lower value that is usual when bonding an aluminum wire.

The bonding wire, the manufacturing process and the wedge-wedge ultrasound wire bonding process will now be explained in greater detail with reference to example variants. The attached figures will serve to elucidate the subject matter. The same reference numbers are used for identical parts or for parts with identical effects.

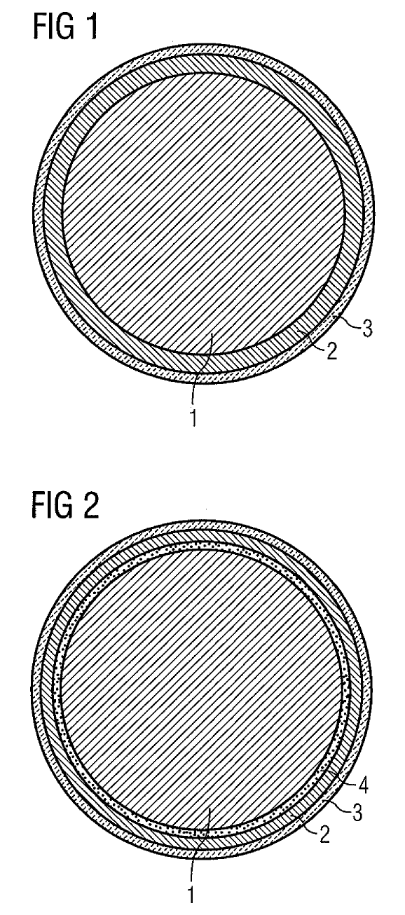

FIG. 1 illustrates a cross-section of an example bonding wire suitable for use in a semiconductor device. The metallic wire core 1 consists of a metal with a higher thermal and electrical conductivity and has a higher hardness than bonding wires commonly used.

Thus, for example, the wire core for a bonding wire with which high-performance semiconductor elements are bonded is made out of copper instead of the aluminum otherwise used for this purpose. A copper alloy can also be used instead of the copper. Moreover, the wire core can consist of a comparable other metal or a corresponding metal alloy.

The diameter and the material of the wire core are essentially determined by the electrical and thermal conductivity of the material and the required electrical and thermal resistance depending on the corresponding cross-sectional area. A wire core consisting of copper, for example, which has a lesser cross-sectional area than a corresponding bonding wire made out of aluminum therefore exhibits an electrical or thermal resistance that is the same as that of the aluminum wire.

The diameter of the wire core can therefore be reduced in relation to the required resistance parameters. Values for the wire core lie in the range of 20 μm for electronic components of low and medium performance and up to 600 μ and more for high-performance components.

The wire core is enveloped in a metallic coating 2. This consists of a metal or metal alloy with a lower hardness than that of the wire core. The material and the thickness of the coating are essential determined by the expedient or desired bonding parameters. The coating is generally designed so as to enable bonding of the coated wire essentially with the bonding parameters that are applicable to a wire that consists entirely of the material of the coating.

It is necessary to take into account the fact that a bonding wire with a greater diameter of the wire core requires a thicker coating for perfect and reliable bonding on the pad or pin. Generally, the diameter of the wire core 1 is greater than the thickness of the coating 2 by a factor of approximately one thousand. Accordingly, a wire core with a diameter of 20 μm has a metallic coating with a thickness of at least 20 nm. Accordingly, a coating with a thickness of at least 600 nm is expedient for a wire core with a diameter of 600 μm. The coating can be thicker, however. Generally, a coating with the thickness of approximately 100 nm to approximately 10 μm is possible for a common bonding wire with a wire core diameter of 100 μm, for example.

On its outer side, the coating has an oxide layer 3, which either forms spontaneously in contact with air, or whose formation has been forced. Its thickness is essentially independent of the wire's thickness and corresponds to the usual thickness of an oxide layer on the respective material of the metallic coating. In the case of coatings made of aluminum or aluminum alloys, the oxide layer has a typical thickness of 4 to 15 nm. The oxide layer has passivating characteristics, which largely rule out corrosion of the bonding wire.

FIG. 2 illustrates a cross-section of an example bonding wire with an additional adhesion promotion layer 4 between the wire core 1 and the metallic coating 2. The adhesion promoter serves to stabilise the coating on the wire core and is applied optionally. The thickness of the adhesion promoter is in the region of a few nanometres to micrometers. Layer thicknesses of 50 nm to 200 nm are used for the adhesion promoter.

Use is made of a gas phase deposition process to produce the coated bonding wire. Such processes are known by the name of “PVD processes”, among other names. PVD stands for “physical vapour deposition”. The coating process is based on deposition of the material to be coated out of the gas or vapour phase under controlled conditions regulating the layer thickness in a vacuum at a pressure in the region of 10⁻⁴ to 1 Pa. The coating material is vaporised by suitable processes and condenses on the surface to be coated.

For coating, a wire blank is placed in a system for gas phase deposition. The material intended for coating 2 is brought to the vapour phase. A large number of diverse processes can be used for vaporisation. For example, thermal vaporisation, heating of a highly pure sample of aluminum with a purity of 99.9% or an aluminum alloy with a well-defined composition is suitable for converting aluminum to the vapour phase.

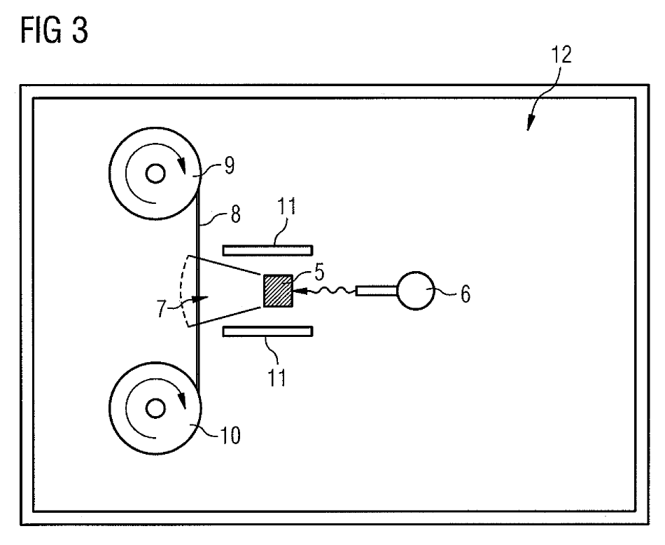

A cathode atomisation process known as sputtering offers another possibility. FIG. 3 illustrates an example of a sputtering system for continuous coating.

In the case of the example illustrated, ions rich in energy are fired out of an ion source 6 at a target 5 consisting of the material intended for coating the wire blank, for example highly pure aluminum or the aluminum alloy. These ions release atoms from the target and convert them to the gas phase. The released atoms fill out a radiation range 7, whose extension is determined by the average distance of the particles within the sputtering system.

The wire blank 8 is guided at a constant speed through the radiation range 7 of the target 5. A feed unit 9 and a discharge unit 10 for the wire blank, for example a coil unit, are located outside the radiation range 7 and, if necessary, are protected by a screen 11 against impact with the coating material. As a result, only those segments of the wire blank are coated that are located within the radiation range of the target. The entire setup, but at least the ion source, the target and the segment of the wire blank located outside the radiation range are located in a vacuum chamber 12.

On the discharge unit 10, the bonding wire provided with a defined coating thickness is gathered, for example it is coiled up. The thickness of the coating can be regulated easily via the feed rate of the wire blank or via the energy and particle density of the ion beam aimed at the target, but also by the pressure in the vacuum chamber.

Via controlled feeding of a process gas, in particular oxygen, it is also possible to additionally adjust the thickness of the oxide layer on the coating or to epitactically apply another additional coating.

Further variants of gas phase coating can also be applied, for example electron or laser beam vaporisation or a molecular beam epitaxy process.

Depending on the material of the wire bonding blank, in certain circumstances it is expedient to remove oxides existing on the surface of the wire blank before coating. Chemical reduction processes can be used for this purpose. It is also possible to remove the oxide layers by a sputtering process.

An example of a wedge-wedge bonding process with such a bonding wire is provided in the otherwise known manner. The bonding parameters, in particular the pressing force of the wedge and the intensity of the ultrasound acting on the wedge are set to values that are less in terms of their amounts than the bonding parameters for a bonding wire consisting of pure copper. Essentially, the set bonding parameters correspond to those of a bonding wire made out of aluminum, which are familiar to the expert.

Thanks to the coating, the mechanical stresses during wire bonding are reduced by use of the softer material. This effect particularly clearly manifests itself in the case of an aluminum coating on a copper wire core. Reduction of mechanical stress results from the comparison with wire bonding of a pure copper wire of clearly lower values for the pressing force and the ultrasound intensity as crucial bonding parameters.

Provided the mechanical strength of the contact area to be bonded, in particular of the pad on the surface of the semiconductor component is adequately known in relation to increases in the bonding parameters, it is also possible to choose bonding parameters that lie between those for bonding wires made out of copper and those for aluminum. This creates an additional technically useful leeway for the bonding process.

Provided the pads on the semiconductor element or the pins on the surrounding housing have a copper coating, the aluminum coating on the bonding wire effectively protects the surface of the copper wire core against oxidation. In conjunction with this, the electrical and thermal characteristics are improved clearly by the better electrical and thermal conductivity of the copper wire core.

When the adhesion promoter A2 is used, which is common in semiconductor technology, peptisation of a Cu—NiP contact in the A2 electrolyte is avoided when using the bonding wire described. As a result, the problem of aluminum under-etching on the Al—NiP contact due to the potential difference between aluminum and NiP materials can be avoided.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor device comprising:
a semiconductor;
a pad;
a bonding wire coupled between the semiconductor and the pad, the bonding wire comprising a metallic wire core and a metallic coating enveloping the wire core, the metallic wire core having a higher hardness relative to the metallic coating.

2. The device of claim 1, comprising where the coating has higher bonding properties relative to the wire core.

3. The device of claim 1 comprising:
where the bonding wire is wedge-wedge wire bonded between the semiconductor and the pad.

4. The device of claim 1, comprising where the wire core consists of a precious metal.

5. The device of claim 4, where the wire is made of gold, a gold alloy, copper, or a copper alloy.

6. The device of claim 1, comprising wherein the coating consists of a light alloy.

7. The device of claim 1, comprising where the coating is made of aluminum or an aluminum alloy.

8. The bonding wire of claim 1, comprising wherein the wire core has a diameter in the region of up to 1 mm, up to 600 μm and the coating has a thickness in the region of up to 3 μm, up to 600 nm.

9. The bonding wire of claim 1, comprising wherein the coating exhibits a surface oxide layer with a layer thickness of up to 100 nm.

10. A manufacturing process for making a semiconductor device comprising:
coating a metallic wire bonding blank of higher hardness and high electrical and thermal conductivity in a gas phase deposition process with a highly pure metallic coating of lower hardness for the creation of a coated bonding wire; and
using the bonding wire to couple a semiconductor to a pad.

11. The process of claim 10, comprising applying a sputtering process as the gas phase deposition process.

12. The process of claim 10, comprising applying a vacuum vapour deposition process as the gas phase deposition process.

13. The process of claim 10, comprising using copper or a copper alloy for the wire bonding blank.

14. The process of claim 10, comprising using aluminum or an aluminum alloy as the target for the gas phase deposition process.

15. The process of claim 10, comprising wherein before the start of the gas phase deposition process a process for reduction of an oxide layer on the wire bonding blank is realised.

16. A process for making a semiconductor device including a wedge-wedge ultrasound wire bonding process comprising:
using a bonding wire with a metallic wire core of higher hardness and a metallic coating of lower hardness enveloping the wire core; and
defining at least one bonding parameter, including a pressing force of a wedge onto a bonding point and/or an ultrasound intensity applied to a the wedge, is set to a lower value for bonding a bonding wire consisting completely of the material of the metallic coating.

17. The process of claim 16, comprising:
wherein the pressing force of the wedge substantially corresponds to a usual pressing force and/or an ultrasound intensity for a bonding wire made out of aluminum or aluminum alloy.

18. A bonding wire for use in a wedge-wedge wire bonding process for bonding a semiconductor element comprising:
a metallic wire core of higher hardness and high electrical and thermal conductivity; and
a metallic coating of lower hardness enveloping the wire core.

19. The bonding wire of claim 18, comprising wherein the wire core consists of a precious metal.

20. The bonding wire of claim 18, comprising where the precious metal is gold, a gold alloy, copper or a copper alloy.

21. The bonding wire of claim 18, comprising wherein the coating consists of a light alloy.

22. The bonding wire of claim 21, where the light alloy is aluminum or an aluminum alloy.

23. The bonding wire of claim 18, comprising wherein the wire core has a diameter in the region of up to 1 mm, up to 600 μm and the coating has a thickness in the region of up to 3 μm, up to 600 nm.

24. The bonding wire of claim 18, comprising wherein the coating exhibits a surface oxide layer with a layer thickness of up to 100 nm.

25. A manufacturing process for a bonding wire, the process comprising:
coating of a metallic wire bonding blank of higher hardness and high electrical and thermal conductivity in a gas phase deposition process with a highly pure metallic coating of lower hardness for the creation of a coated bonding wire.

26. The process of claim 25, comprising wherein a sputtering process is applied as the gas phase deposition process.

27. The process of claim 25, comprising wherein a vacuum vapour deposition process is applied as the gas phase deposition process.

28. The process of claim 25, comprising wherein the wire bonding blank consists of copper or a copper alloy.

29. The process of claim 25, comprising wherein aluminum or an aluminum alloy is used as the target for the gas phase deposition process.

30. The process of claim 25, comprising wherein before the start of the gas phase deposition process a process for reduction of an oxide layer on the wire bonding blank is realised.

31. A wedge-wedge ultrasound wire bonding process, comprising:
using a bonding wire with a metallic wire core of higher hardness and a metallic coating of lower hardness enveloping the wire core, wherein at least one bonding parameter, including the pressing force of a wedge onto a bonding point and/or an ultrasound intensity applied to the wedge, is set to a usual, in particular lower, value for bonding a bonding wire consisting completely of the material of the metallic coating.

32. The wedge-wedge wire bonding process of claim 31, comprising wherein the pressing force of the wedge essentially corresponds to the usual pressing force and/or the ultrasound intensity for a bonding wire made out of aluminum or aluminum alloy.
